(19) United States
(12) Patent Application Publication
(10) Pub. No.: US 2026/0259924 A1
(43) Pub. Date: Sep. 3, 2026

(54) GENERATING AN LLM AGENT HUB AND AGENT WORKFLOW

(71) Applicant: Microsoft Technology Licensing, LLC, Redmond, WA (US)

(72) Inventors: Anush SANKARAN, Vancouver (CA); Amir Hossein ABDI, Vancouver (CA); Tong WANG, Montreal (CA); Michael Charles ALBADA, Seattle, WA (US)

(21) Appl. No.: 19/067,437

(22) Filed: Feb. 28, 2025

(51) Int. Cl. G06F 16/383; G06F 40/20

(52) U.S. Cl. CPC G06F 16/383; G06F 40/20

(57) ABSTRACT

Techniques for automatically enhancing a hub of LLM agents are disclosed. A service accesses a computer-based task that includes a set of parameters and requirements. The service accesses the hub of LLM agents. The service queries the hub of LLM agents using the set of parameters and requirements to identify one or more LLM agents whose functionalities and score cards are determined to satisfy the set of parameters and requirements. Based on the query, the service identifies a set of LLM agents that are tasked with attempting to generate a solution for the computer-based task. The service tasks the set of LLM agents to operate in an attempt to generate the solution for the computer-based task.

### BACKGROUND

A “large language model” (LLM) is a specialized type of machine learning (ML) or artificial intelligence (AI) model that has been trained on a large set of data. The data can be of any type, though it is often text-based data. Image data, video data, and other data types can also be used. With its training, the LLM is able to understand and produce output that resembles human-generated output. As various examples, an LLM can be tasked with translating input from one language (e.g., perhaps English) to another language (e.g., perhaps Spanish). LLMs can be tasked with answering questions, writing code, analyzing language patterns, and writing creative content. LLMs can be involved with an “agent.”

An “agent” is a type of system or service that leverages one or more LLMs to perform a task, which refers to a unit of work that needs to be performed. Notably, an agent is a type of autonomous system that can “think” and act on its own; meaning, it can operate without specific instructions from a user. An LLM will respond to a question if asked. For instance, if an LLM is asked: “What is the price of a plane ticket to Machu Pichu?” the LLM can generate a response. An agent, on the other hand, can not only provide a response, but it can also go about scheduling and paying for the flight. The agent can also book a hotel and vehicular travel arrangements.

The subject matter claimed herein is not limited to embodiments that solve any disadvantages or that operate only in environments such as those described above. Rather, this background is only provided to illustrate one exemplary technology area where some embodiments described herein can be practiced.

### BRIEF SUMMARY

In some aspects, the techniques described herein relate to a method for automatically enhancing a hub of large language model (LLM) agents, said method being performed by a cloud-based service and including: accessing a computer-based task that includes a set of parameters and requirements; accessing the hub of LLM agents, wherein the hub of LLM agents includes a plurality of different LLM agents, which include metadata including: (i) an identified core LLM used by said LLM agent, (ii) a score card for said LLM agent, and (iii) a listing of one or more functionalities said LLM agent is able to perform; querying the hub of LLM agents using the set of parameters and requirements to identify one or more LLM agents whose functionalities and score cards are determined to satisfy the set of parameters and requirements; based on said querying, identifying a set of LLM agents that are tasked with attempting to generate a solution for the computer-based task; determining that the set of LLM agents is deficient with respect to a particular functionality that is determined to be necessary to assist in generating the solution, wherein the set of LLM agents are determined to be deficient when the set of LLM agents are unable to achieve a threshold performance level with respect to the particular functionality; in response to determining that the set of LLM agents is deficient, authoring, by the cloud-based service, a new LLM agent that is defined to have the particular functionality determined to be necessary to assist in generating the solution; including the new LLM agent in the hub of LLM agents, wherein the new LLM agent is provided corresponding metadata detailing (i) a particular core LLM used by the new LLM agent, (ii) a particular score card for the new LLM agent, and (iii) a particular listing of functionalities for the new LLM agent, the particular listing of functionalities including the particular functionality; including the new LLM agent in the set of LLM agents; and tasking the set of LLM agents to operate in an attempt to generate the solution for the computer-based task.

In some aspects, the techniques described herein relate to a computer system including: a processor system; and a storage system that stores instructions that are executable by the processor system to cause the computer system to: access a computer-based task that includes a set of parameters and requirements; access the hub of LLM agents, wherein the hub of LLM agents includes a plurality of different LLM agents, which include metadata including: (i) an identified core LLM used by said LLM agent, (ii) a score card for said LLM agent, and (iii) a listing of one or more functionalities said LLM agent is able to perform; query the hub of LLM agents using the set of parameters and requirements to identify one or more LLM agents whose functionalities and score cards are determined to satisfy the set of parameters and requirements; based on said querying, identify a set of LLM agents that are usable to attempt to generate a solution for the computer-based task; and task the set of LLM agents to operate in an attempt to generate the solution for the computer-based task.

In some aspects, the techniques described herein relate to a storage system that stores instructions that are executable by one or more processors to cause the one or more processors to: access a computer-based task that includes a set of parameters and requirements; access the hub of LLM agents, wherein the hub of LLM agents includes a plurality of different LLM agents, which include metadata including: (i) an identified core LLM used by said LLM agent, (ii) a score card for said LLM agent, and (iii) a listing of one or more functionalities said LLM agent is able to perform; query the hub of LLM agents using the set of parameters and requirements to identify one or more LLM agents whose functionalities and score cards are determined to satisfy the set of parameters and requirements; based on said querying, identify a set of LLM agents that are usable to attempt to generate a solution for the computer-based task; and task the set of LLM agents to operate in an attempt to generate the solution for the computer-based task.

In some aspects, the techniques described herein relate to a method for authoring an end-to-end workflow for a set of large language model (LLM) agents tasked with generating a solution to a computer-based task, said method including: access a computer-based task that includes a set of parameters and requirements; access a hub including multiple LLM agents that are available for selection to generate a solution to the computer-based task; query the hub using the set of parameters and requirements to identify a set of LLM agents that are determined to have a level of similarity that meets a threshold with respect to satisfying the set of parameters and requirements; access an orchestration that is statically defined and that controls how the LLM agents in the set of LLM agents are permitted to interact with one another; build a workflow for the set of LLM agents, the workflow being structured to control run-time interactions between the LLM agents in the set of LLM agents and being dependent on the orchestration; cause the set of LLM agents to execute in an attempt to generate the solution for the computer-based task, wherein the set of LLM agents, during run-time, are governed by the workflow.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or can be learned by the practice of the teachings herein. Features and advantages of the invention can be realized and obtained by means of the instruments and combinations particularly pointed out in the appended claims. Features of the present invention will become more fully apparent from the following description and appended claims, or can be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture designed to facilitate the creation of an LLM agent hub, score cards for the LLM agents, and an end-to-end workflow for the LLM agents.

FIG. 2 illustrates an example of the LLM agent hub.

FIG. 3 illustrates an example process flow for creating the agent hub.

FIG. 4 illustrates an example process flow for creating the score cards for LLM agents.

FIG. 5 illustrates an example process flow for generating a workflow for the LLM agents.

FIG. 6 illustrates a task solution process flow.

FIGS. 7A and 7B illustrate flowcharts of an example method for automatically enhancing a hub of LLM agents.

FIG. 8 illustrates a flowchart of an example method for authoring an end-to-end workflow for a set of LLM agents tasked with generating a solution to a computer-based task.

FIG. 9 illustrates an example computer system that can be configured to perform any of the disclosed operations.

### DETAILED DESCRIPTION

An agent operates on top of an LLM in that the agent can use the LLM to complete its tasks. An agent also includes memory and tools or functionality. Using its memory, the agent can recall information from past sessions. Using its tools, the agent can facilitate the completion of tasks, such as the scheduling mentioned above. Agents can have access to external databases, application programming interfaces (API), or any other utility. At its highest level of description, however, an agent can be viewed as being an executable service or component having access to an LLM that operates at the core of the agent. The LLM helps to process information and to assist in deciding what decisions will be taken by the agent. Additional memory, action-taking skills, or tools can be plugged into the agent to further expand its functionality.

Agents are becoming a revolutionary technology in almost every domain, especially in the computing security domain. The computing security domain is one where it is necessary to act proactively and autonomously to defend computers against any kind of attack. Historically, when an attack happens against a computing system, the conventional protection mechanisms might take hours, days, or sometimes even weeks to recognize that an attack has happened. The conventional protection mechanisms then attempt to build a defense against these attacks.

Recently, agents have been tasked with operating as defensive agents to help protect against computing attacks. These defensive agents can proactively identify and recognize (e.g., in real time) that an attack has happened or is ongoing. The defensive agent can then act on its own to protect against the pending attack. Advantageously, the agent does not need human intervention such that these defensive agents are autonomous systems. While agents are providing significant benefits in the field of computing security, there is still a substantial need to improve the use of agents in this field. The disclosed embodiments provide solutions to these substantial needs.

It should also be noted how one of the biggest challenges with agents involves the definition of an agent and the implementation of that agent. Currently, defining an agent is a unique and niche skill requiring the involvement of an expert human developer. It is becoming increasingly difficult for software developers and data scientists to implement agents in their products or programming scenarios due to the high level of skill historically needed to define an agent. An example, which is provided below, will be helpful.

For instance, one of the biggest security challenges faced by developers today relates to detecting phishing emails. Now, consider a scenario where it is desirable to define an agent, or rather a group of agents, to proactively examine emails to detect phishing attacks. What happens today is that a group of expert human developers write code for the “definition” and “orchestration” of an agent tasked with detecting phishing emails. That is, the experts will provide a definition for the agents and how the agents are to communicate and orchestrate between themselves to solve the complex task of phishing detection. The expert developers also write code to define the whole “workflow” of how the agents should proactively operate amongst themselves. The expert developers then deploy this agent-based system into production.

From the above description, one can readily observe how this process is highly laborious. This process also involves the participation of numerous expert developers. Because of the “expert” level of skill needed to perform these operations, many teams and productions are not able to take full advantage of agent-based systems because those teams fail to have the requisite level of expertise. Thus, it is desirable to improve how such agent-based systems are generated.

The disclosed embodiments are beneficially designed to offer a no-code automated authoring platform that is usable to author agents in a development system, such as by providing a definition for the agent, an orchestration for a group of agents, and a workflow for the group of agents. Prior to delving further into how these benefits are achieved, some additional context regarding “definition,” “orchestration,” and “workflow” is warranted.

The “definition” of an agent refers to code indicating what an agent is tasked with doing. For instance, the definition of an agent can be that the agent is tasked with identifying and responding to phishing attacks. The definition is statically defined when the agent is created.

The “orchestration” for a group of agents is also a static definition and indicates which agents can communicate with one another. For instance, the orchestration can indicate that Agent A can communicate with Agent B and Agent C. Agent B can communicate with only Agent A. Agent C can communicate with Agent A and Agent B. This definition is static and can optionally be provided as a part of the agents’ code definitions, though the orchestration can be provided separately from the agent definitions. The orchestration can also indicate by what technique or API one agent is to communicate with another agent. In some scenarios, the default orchestration is setup to allow all agents to communicate with each other. In other scenarios, it can be desirable to limit which agents can communicate with one another to avoid redundant, cyclical, or recursive communications.

The “workflow” for the group of agents describes what can occur during runtime given the conditions or requirements outlined in the orchestration. For instance, in the example above, Agent A can communicate with Agent B and Agent C. During runtime, however, Agent A will perform its processes, such as perhaps extracting data. Depending on the data Agent A extracted, Agent A will then determine, in real-time, which agent (e.g., limited to Agents B and C as defined in the static orchestration) will receive the extracted data. In this example, Agent A can determine that Agent B is to receive the extracted data. This dynamic determination is part of the workflow whereas the limitation of communicating only with Agents B and C is a static definition included in the orchestration. The next time Agent A is called, Agent A might alternatively choose to pass data to Agent C. Thus, the workflow can change throughout different calls to different agents. The workflow beneficially provides dynamic instructions during runtime, and the workflow can be viewed as being code that defines the whole execution of agents and their interactions during runtime.

As mentioned previously, one of the biggest challenges with agents involves the definition of an agent and the implementation of that agent. The disclosed embodiments are designed to beneficially address those challenges. That is, the disclosed embodiments provide significant benefits, advantages, and practical applications in the definition, orchestration, and workflow of LLM agents. With the increasing complexity and volume of cyber threats, security teams struggle with analyzing data, summarizing incidents, generating reports, and executing investigation plans efficiently. The disclosed embodiments are beneficially structured to facilitate the generation of a robust, automated system capable of handling these tasks to improve security measures, reduce reaction times, and free up human resources for more critical thinking and strategic planning.

Beneficially, at least some embodiments can assist security operations center (SOC) analysts in monitoring, detecting, analyzing, and responding to security incidents effectively. At least some embodiments can also beneficially assist incident response teams by summarizing detailed security reports and generating easily understandable briefs. At least some embodiments can beneficially assist threat intelligence teams by analyzing uniform resource locators (URLs) for malicious content quickly and efficiently. At least some embodiments can beneficially assist information technology (IT) administrators by converting natural language queries into KQL for advanced data analytics. At least some embodiments can beneficially assist cybersecurity analysts by planning and executing in-depth investigation plans on potential threats.

To achieve those benefits, as well as many others, at least some embodiments are structured to build a cloud-based hub of autonomous LLM agents (or simply “agents”). The term “hub” generally refers to an accessible collection or repository of one or more LLM agents that are made available for download or other use. The hub can be stored in a local storage system or in a network storage system, such as a cloud environment. Here, an individual agent is specialized to solve at least one specific atomic task. In some scenarios, new agents are contributed in a manual manner to the hub while in other scenarios, new agents are automatically authored by a service or controlling agent and added to the hub by that service.

At least some embodiments are also structured to automatically compute a security “score card” for the agents. The score card provides a quick measure of the robustness of the agent against attacks, vulnerability analysis, and other responsible AI measures.

At least some embodiments are also beneficially structured to autonomously solve complex tasks by authoring an end-to-end agent workflow. The term “authoring” generally refers to the process of defining functionalities and operations for an LLM agent and then potentially attending to the creation of the LLM agent based on the definition. For instance, some embodiments manually pick-and-chose agents to construct an agent-based workflow. These embodiments also automatically construct an agent-based workflow using a meta agent (i.e. the lead agent or the primary controlling agent) setup. The “service” mentioned later in this disclosure can be viewed as being an instance of this “meta agent.”

The secure agent hub advantageously employs a cloud-based ecosystem that integrates multiple autonomous agents, where an agent is equipped with specific core functionalities powered by advanced LLMs. These agents are either manually or automatically authored, and they interact through defined APIs and prompts, thereby enabling the effective resolution of complex security tasks. Agents can optionally be manually authored by experts who create agents by defining the purpose, writing code, prompts, and functions that are then uploaded via an API to the secure agent hub. Agents can optionally be automatically authored by an LLM, LLM agent, or service, which is tasked with automatically generating agents based on defined purposes and by bundling the purposes into an agent definition. The authoring entity can then upload the agent to the secure agent hub.

Regarding the security score card, a score card can be automatically computed for an agent based on metrics such as a RedTeam score, an error score, a causal score, an explainability score, and a fairness score, among others. These scores can be computed by exercising the agent through a number of tests. The term “RedTeam” refers to a group of developers tasked with simulating an attack against a computing construct in an effort to test the construct to determine its vulnerability to different attacks. In effect, the RedTeam is a group that mimics an enemy or malicious entity but does so in a controlled environment.

Regarding the complex task solving through the use of an agent-based workflow, at least some embodiments either manually construct workflows by expert users or automated workflows through the use of the meta agent, thereby addressing complex tasks like email phishing detection.

In performing these operations, at least some embodiments automate threat analysis and reduce human error and workload by leveraging LLMs for automated agent generation and task execution. Feedback loops can be employed to enable iterative enhancement of agent performance and workflow efficiency. Multi-dimensional security evaluation can be performed, and comprehensive performance scoring across multiple metrics and domains ensures robust and balanced agent behavior. At least some embodiments are scalable, and cloud-based deployment supports scaling up resources and capabilities in response to evolving security needs. Current security platforms often rely on rigid, manual tools and human effort for different stages of threat analysis and response. In contrast, at least some of the disclosed embodiments are able to dynamically and automatically generate agents.

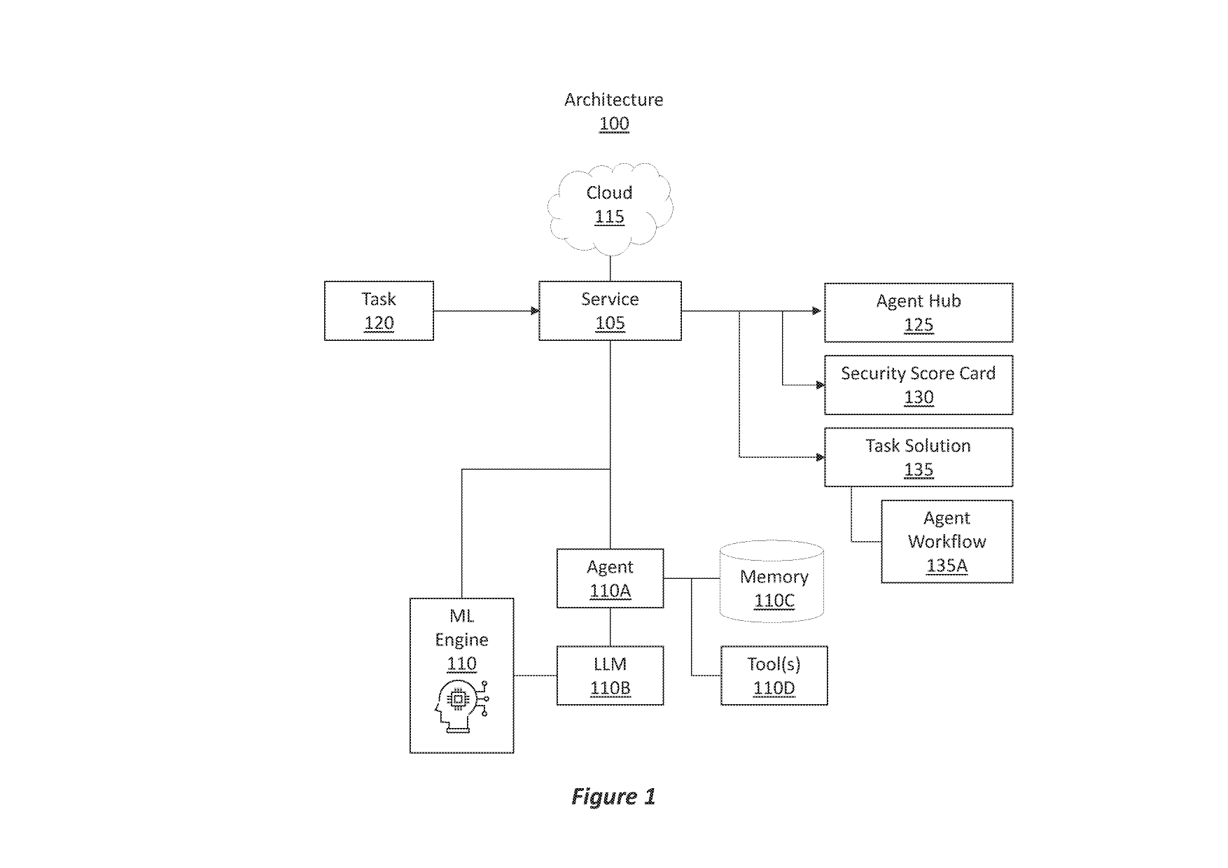

Having just described some of the high level benefits, advantages, and practical applications achieved by the disclosed embodiments, attention will now be directed to FIG. 1, which illustrates an example computing architecture 100 that can be used to achieve those benefits. Architecture 100 includes a service 105. The service 105 can be viewed as being the “meta agent” mentioned earlier.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 110. The ML engine 110 enables the service 105 to operate even when faced with a randomization factor.

The ML engine 110 can be or can include an agent 110A. The agent 110A operates on top of an LLM 110B, which can also be included as a part of the ML engine 110. Agent 110A can include or be associated with memory 110C and any number of different tool(s) 110D, which refer to specialized utility or functionality defined for the agent 110A to use. As will be described in more detail later, service 105 is generally tasked with building a cloud-based hub of autonomous agents (e.g., agent 110A), as shown by agent hub 125. Service 105 is also tasked with automatically computing a security score card 130 for agents in the agent hub 125. Service 105 is further tasked with facilitating the autonomous solving of a complex task 120 by a set of selected agents, where the task solution 135 to the complex task 120 is orchestrated by the service 105 authoring an end-to-end agent workflow 135A.

As used herein, reference to any type of machine learning, LLM, agent, or artificial intelligence can include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), generative pre-trained transformer (GPT), or any other type of intelligent computing system. Any amount of training data can be used (and perhaps later refined) to train the machine learning algorithm to dynamically perform the disclosed operations.

In some implementations, service 105 is a cloud service operating in a cloud 115 environment. In some implementations, service 105 is a local service operating on a local device. In some implementations, service 105 is a hybrid service that includes a cloud component operating in the cloud 115 and a local component operating on a local device. These two components can communicate with one another.

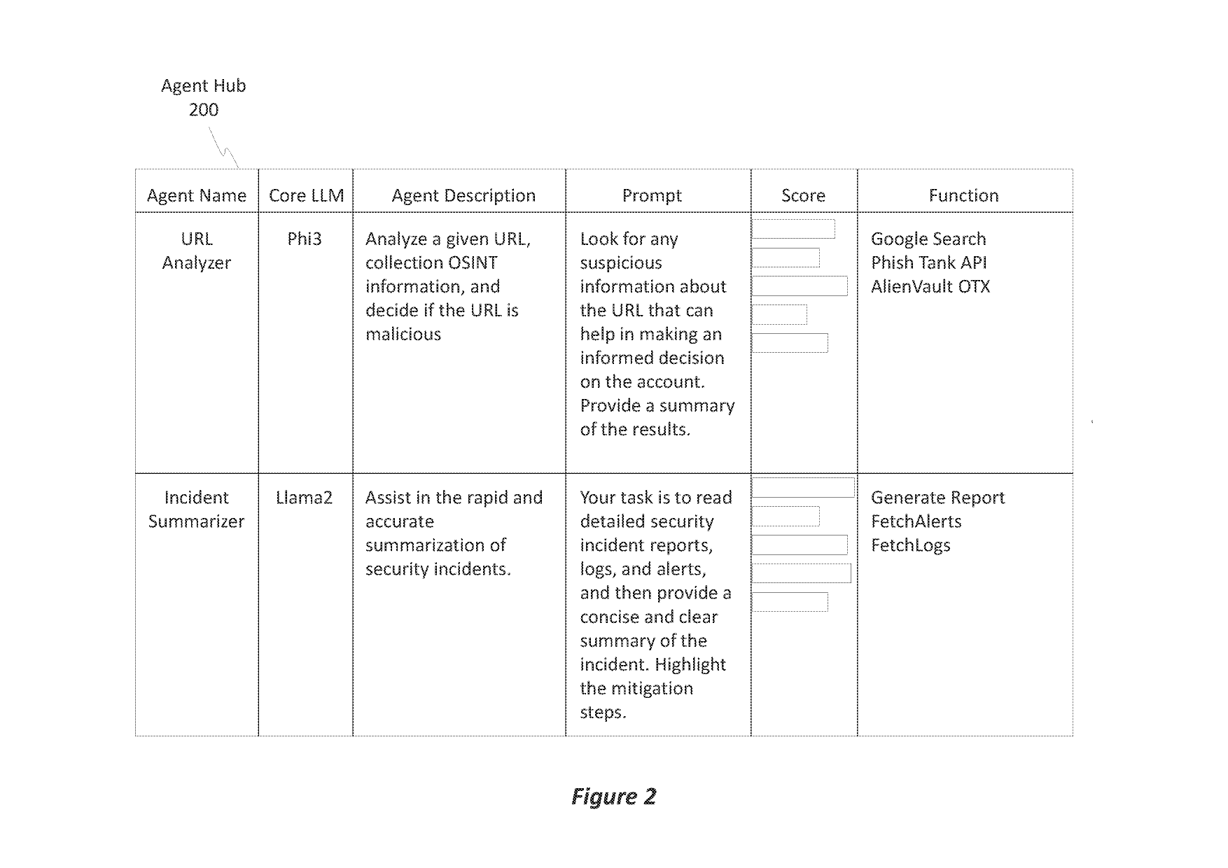

As mentioned above, service 105 is tasked with generating the agent hub 125. FIG. 2 provides an example illustration of an agent hub 200. Agent hub 200 maintains a listing of different agents, including the name of the agent, the core LLM used by the agent, the description of the agent, the prompt for the agent, the score card for the agent, and the functionality of the agent (e.g., what skills or actions can the agent perform).

In FIG. 2, the agent hub 200 lists two different agents, namely, the URL analyzer agent and the incident summarizer agent. One will appreciate, however, how the number of agents in the agent hub 200 can be unlimited. Thus, the agent hub 200 operates as a searchable index or searchable repository that stores and maintains the various different agents that are available for immediate use.

Descriptive metadata (e.g., the name, core LLM description, prompt, score, function, etc.) about the various different agents is included in the agent hub 200. The agent hub 200 provides significant opportunities for reusability of the agents across different products or use case scenarios. For instance, a large number of products require or desire the use of a URL analyzer agent. This URL analyzer agent can be defined once and then made available for different applications or products via the agent hub 200. The agent hub 200 also promotes standardization of LLM agents. Further details on how the agent hub 200 is generated will be provided later.

Assuming the agent hub 200 is available, and now referring back to FIG. 1, when a complex task 120 is received, service 105 (i.e. the “meta agent” mentioned earlier) can automatically review the task 120. Based on the details (e.g., parameters, requirements, desired features, specifications, etc.) included in the defined task 120, service 105 will then determine which one or more agents to download or otherwise access from the agent hub 125. These selected agents are ones the service 105 determines will be able to work together to provide a solution to the complex task 120. By way of additional example, “parameters” can be any programming feature or aspect that is desirable. For instance, examples of parameters include, but are not limited to, timing or latency metrics, processor usage metrics, memory consumption metrics, the number of LLM agents involved, the location of stored data, and so on. Requirements can be any programming feature or aspect that is required. For instance, examples of requirements include, but are not limited to, any of the above parameters (but now listed as a requirement), security requirements (e.g., authorization or data protection features), and so on.

That is, service 105 is able to identify which one or more agents are able to either individually or as a collection work together to accomplish the task 120. Service 105 can also automatically determine the orchestration and workflow for these selected agents, and service 105 can provide the mechanisms needed to connect the agents together to achieve the defined workflow, based on the conditions outlined in the orchestration.

As to the creation of the agents that are retained or managed by the agent hub 125, service 105 can either create the agents itself or coordinate the creation of the agents, such as via the use of an offline agent creation system or an LLM tasked with creating the agents. The creation of an agent can be triggered in numerous ways.

In one scenario, an agent is created when a new concept for an agent is developed, even though there might not be an immediate need for the agent. In another scenario, a new need for a specialized agent may arise, and the specialized agent can be created in response to that new and immediate need.

As an example, suppose a new complex task is received by the service 105. Service 105 will then query the agent hub 125 to identify one or more agents that can handle the complex task. For example, service 105 may examine the listed set of functions the agents can perform and determine whether those functions are suitable for solving the task.

It may the case, however, that the relevant agent has not yet been created and is not included in the agent hub 125. In such a scenario, service 105 can then trigger the generation of that new agent. The new agent can then be stored in the agent hub 125 and made available for use to complete the new complex task. In some scenarios, service 105 might determine that multiple new agents are needed, so service 105 can trigger the authoring of those multiple new agents.

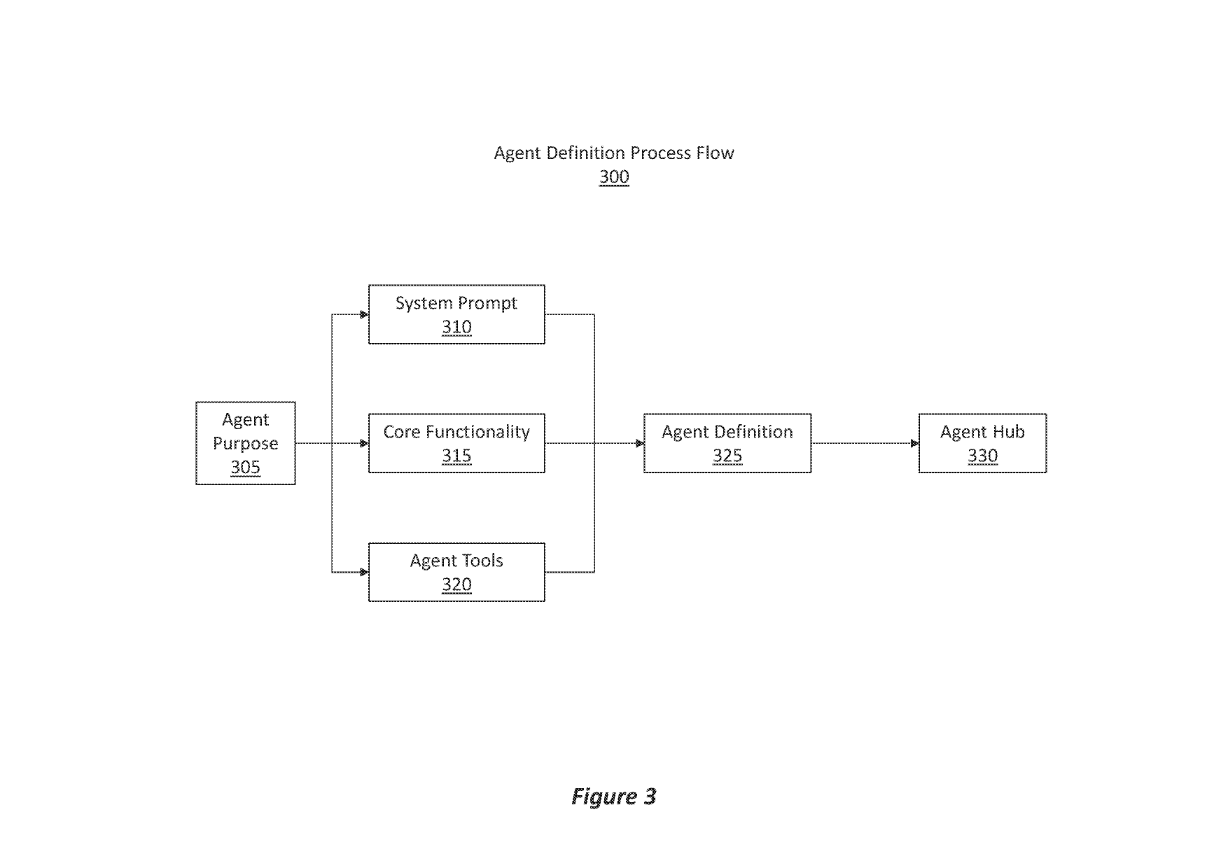

As for the creation of an agent, FIG. 3 shows an example agent definition process flow 300. The agent definition process flow 300 can be performed by service 105 of FIG. 1. In scenarios where the agent is created manually via an expert, the expert can perform the agent definition process flow 300. In most situations, however, the service 105 is performing the agent definition process flow 300.

An agent, by definition, should have a system prompt, a process or functionality (i.e. the code the agent executes when the agent is called), and a list of tools the agent has access to. To generate the agent, an agent purpose 305 is defined. This agent purpose 305 is used to generate the system prompt 310, the core functionality 315, and the agent tools 320. That is, the agent purpose 305, which is used to generate the system prompt 310, the core functionality 315, and the agent tools 320, can be generated by the service 105, or rather, by an LLM of the service 105. As one example, the agent purpose 305 for a URL analyzer may be the following: “The purpose of this agent is to look for any suspicious information about a URL that can help in making an informed decision on the account.”

Based on the agent purpose 305, the LLM of the service can then generate specific text used for the system prompt 310, specific code used for the core functionality 315, and specific code used for the agent tools 320.

The system prompt 310, core functionality 315, and agent tools 320 are then used to generate the agent definition 325 for the agent. The agent is then generated based on the agent definition 325. The resulting agent can then be included in the agent hub 330, which corresponds to the agent hubs 125 and 200 of FIGS. 1 and 2, respectively.

The resulting agent can be packaged in numerous different ways, and the package can be included in the agent hub 330. The package can later be downloaded for use in a specific context. The packaging can be implemented via any type of micro-service. Additionally, or alternatively, the package can involve running specific script (e.g., perhaps Python) and/or can involve a Docker container or some other container type. Service 105 will determine how to package the agent based on the given system architecture.

It should be noted that while LLMs are quite good at generating code (e.g., the specific code mentioned above), improvements in how LLMs generate code can be achieved. At least some of the disclosed embodiments are designed to use feedback from the authoring process to further refine, tune, and improve how the LLM of the service 105 subsequently authors agents, including how the prompt or the agent purpose 305 is authored. In this manner, various different parameters can be collected and analyzed during the authoring process. These parameters can then be used in the feedback loop to suggest later changes and improvements in how the LLM operates to generate code and the agent definition. These parameters, changes, and updates can be performed repeatedly overtime to achieve continued improvement.

Some embodiments employ an exploration phase in which multiple different agents tasked with performing the same functionality are created using variations of an agent purpose. These embodiments can then test the authored agents and subsequently make refinements. Based on the refinements, additional agents can be created in an attempt to author a best version of the agent. Thus, throughout the exploration phase, these embodiments can filter, refine, and prune (e.g., by selecting the configuration parameters that are determined to be working best) the authored agents until a determination is made that a best agent (relative to the ones that have been created) has been authored. This “best” agent may be the one that has a maximum score in a given functionality or a maximum overall/aggregated score. Further details on the scoring aspect will now be provided. It should be noted how at least some embodiments prevent agents from being included in the agent hub if those agents’ scores are below a given threshold.

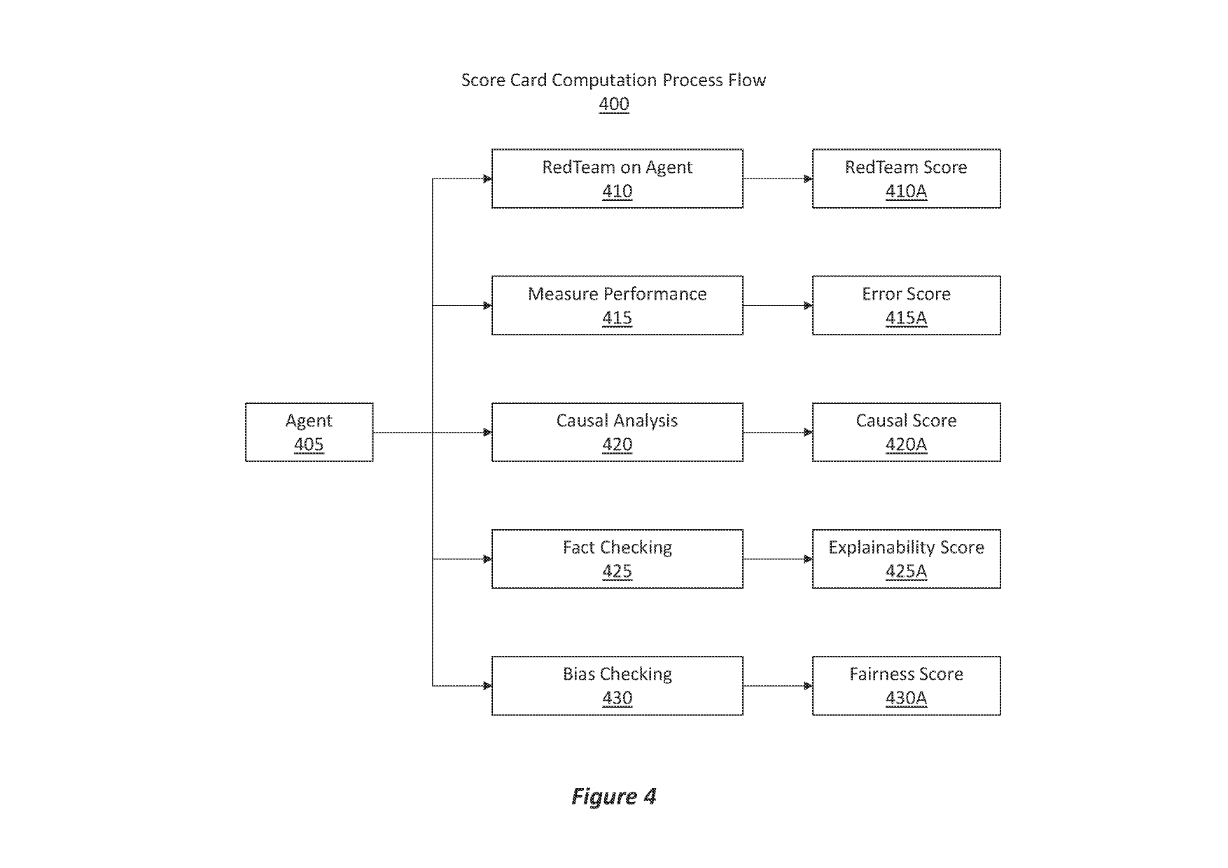

Regarding the scoring and the score card for the agents, FIG. 4 illustrates an example score card computation process flow 400. Service 105 of FIG. 1 can facilitate the performance of the score card computation process flow 400.

Initially, an agent 405 is accessed. Agent 405 can be one that was automatically created via the service 105 or, alternatively, can be one that is manually created by an expert developer. Prior to the agent 405 being included in the agent hub, service 105 causes the agent 405 to be subjected to multiple different tests in order to generate a set of scores for the agent.

One test involves a RedTeam operating on the agent, as shown by reference 410. Another test involves measuring the performance of the agent 405 in completing a given task or objective, as shown by reference 415. Another test involves performing a causal analysis on the agent 405, as shown by reference 420. Another test involves performing fact checking on the agent 405 (or on the results produced by the agent 405), as shown by reference 425. Another test involves performing a bias check, as shown by reference 430. Of course, any number of other tests can also be imposed on the agent 405.

In the example shown in FIG. 4, five different scores are then computed based on the five different tests. For example, a RedTeam score 410A, an error score 415A, a causal score 420A, an explainability score 425A, and a fairness score 430A are generated. In some implementations, the individual scores are aggregated and potentially weighted to form a single overall score for the agent 405. If the scores and/or if the aggregate score meets or exceeds one or more thresholds, then the agent 405 can be included in the agent hub. If the scores fail to meet the threshold(s), then the agent 405 can be excluded from the agent hub.

Optionally, agent 405 can be re-authored over time and/or replaced by a substitute agent in an attempt to create a maximally optimal or at least progressively improved agent over time. To do so, variations on the code and prompts can be tested in an attempt to increase one or more of the scores for the agent. The various different scores can then be included in the security score card 130 shown in FIG. 1 and the “score” column shown in FIG. 2. Preferably, every agent in the hub has an associated set of scores. Users who are using the agents can also provide feedback, which can then be used to further improve and refine subsequent versions of the agent.

The score card beneficially provides a mechanism for measuring the performance of the agent across multiple different dimensions. FIG. 4 provides four example dimensions across which the agent 405 is being scored. One dimension that is not explicitly illustrated in FIG. 4 (though it is included in the RedTeam test) but that is often quite beneficial to test is the vulnerability dimension of an agent. By “vulnerability,” it is generally meant how susceptible to compromise or attack the agent is relative to an attacking entity.

As an example, consider an agent tasked with booking a flight using a user’s credit card. It may be the case that the agent is attacked by a malicious entity seeking to obtain the user’s credit card information. If the agent cannot withstand the attack, thereby resulting in the malicious entity obtaining the credit card information, then the agent is vulnerable and likely needs to be strengthened or otherwise made more robust. Agents can thus be tested in terms of their vulnerability in how they protect data, particularly user confidential data.

Thus, the RedTeam score 410A can generally reflect the ability of the agent 405 to successfully defend against an attack of potentially any type. The error score 415A reflects the accuracy of the agent 405 when operating on an evaluation dataset. The causal score 420A reflects the accuracy of the agent 405 on counter factual examples. The explainability score 425A reflects the accuracy of the agent 405 in correctly extracting factual data and/or how well the agent 405 can explain what it is doing. The fairness score 430A reflects the accuracy of the agent 405 in terms of the number of failed bias indicators.

Having a variety of different scores across different dimensions is of particular benefit for a variety of reasons. For instance, it might be the case that agent 405 is highly accurate in completing a given task, but it might be the case that the agent 405 is highly susceptible to compromise. A developer might not care that the agent 405 is susceptible because the developer has built in other protections to protect data. Thus, the agent 405 might be chosen in such a situation. In an alternative situation, the agent 405 might not be chosen because the other protections were not built in. At least some embodiments can thus tag an agent by including a disclaimer to call out or specifically indicate particular characteristics of an agent, such as a scenario where the RedTeam score might be on the lower end.

When the service 105 (i.e. the meta agent) selects which agents to use to complete a complex task, the service 105 can review the listed functionality for the agents in the agent hub and then make the selection based on the functionalities as well as based on the score cards for the agents. Additionally, when determining how to service the received complex task, service 105 can automatically author an end-to-end agent workflow for the agents the service 105 selected. Optionally, the agent workflow can be authored manually by one or more expert developers. Preferably, the agent workflow is automatically authored by the service 105.

Generally, defining the workflow involves defining the APIs and processes to allow the selected agents to communicate and interact with one another in accordance with the static definitions included in the orchestration. Stated differently, the workflow generally prescribes which agents should talk with which other agents during runtime based on the data currently at hand.

For instance, given a first data set, the workflow may prescribe that Agent A should communicate with Agent B because Agent B needs the first data set to assist in generating the solution for a complex task. At a different time and with a second data set, the workflow may prescribe that Agent A should communicate with Agent C because Agent C now needs the second data set to assist in generating a solution. The workflow can also provide access to other sources, resources, or features for the agents as well. As one example, the workflow can allow an agent to communicate with an external or third-party application to obtain the user’s credit card information so the agent (or another agent) can then book a flight. The workflow is dynamic in that it is not pre-specified or pre-defined prior to runtime. Instead, the service 105 can dynamically change operations based on its intelligence to determine how best to generate a solution to a complex task.

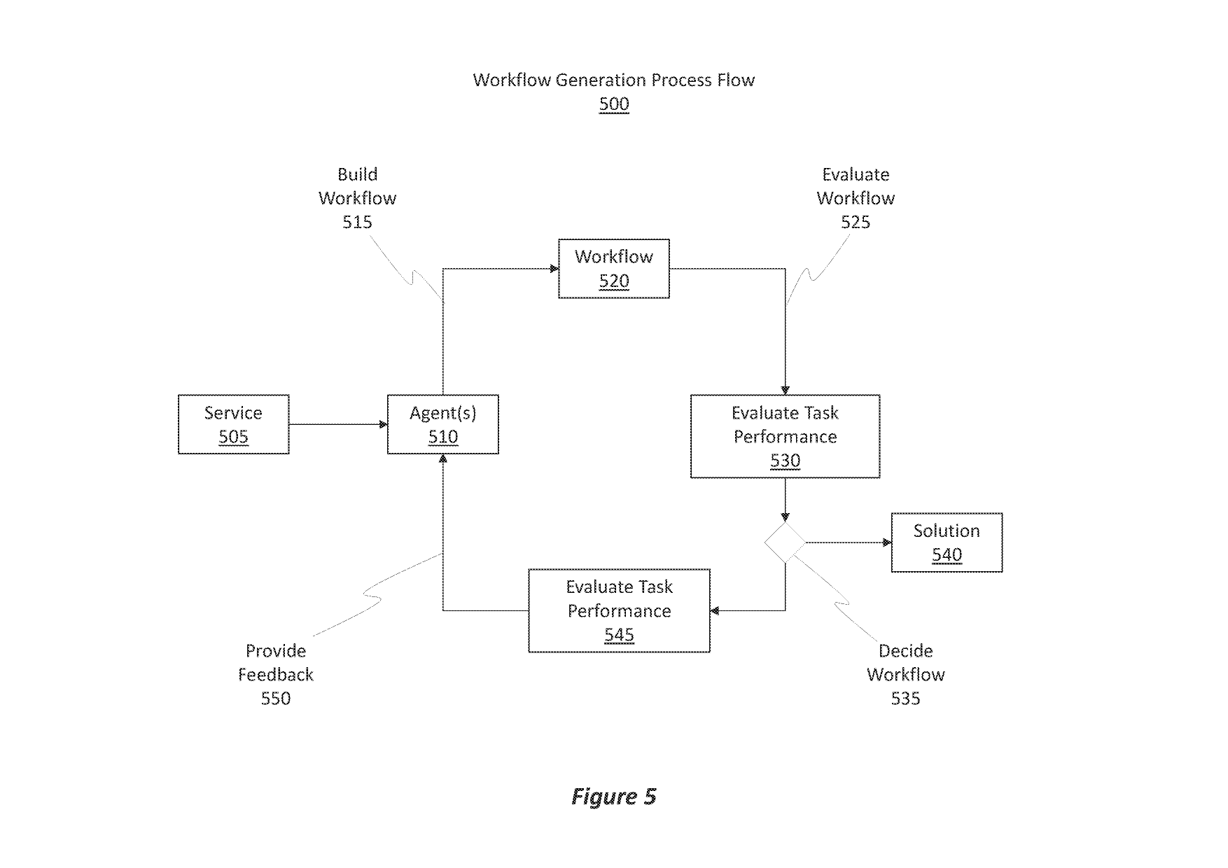

FIG. 5 shows an example workflow generation process flow 500 that is performed by the service 505, which corresponds to the service 105 of FIG. 1. In response to receiving a complex task, service 505 selects and potentially downloads a set of agent(s) 510 from the agent hub. This selection process involves the service 505 identifying the parameters and requirements of the complex task. Service 505 then queries the agent hub based on those parameters and requirements in an attempt to find one or more agents that include functionalities capable of solving the complex task.

If no agents are identified, then service 505 can create the agents to complete the complex task. If agents are identified, then service 505 can include those identified agents in the list of agent(s) 510.

Service 505 is able to compute a similarity score between the current complex task and some, or potentially all, of the agents included in the agent hub. Optionally, multiple similarity scores across multiple different dimensions can be computed. Based on these similarity scores, service 505 will select (or avoid selecting) one or more agents for inclusion in the listing of agent(s) 510. Service 505 will often employ a selection similarity threshold to assist with this selection. For instance, the selection similarity threshold may be set to any value (e.g., in this example, perhaps a value of 90%). If one or more agents are identified as having similarity scores that meet or exceed the selection similarity threshold, then those agents may be chosen.

As far as computing the similarity scores, service 505 will review the list of functionalities for at least some of the agents in the agent hub. If the functionalities are ones that are usable to help solve the complex task (e.g., based on the determined parameters and requirements of the task), then those agents can be considered for inclusion in the listing of agent(s) 510.

After selecting the agent(s) 510, service 505 then builds the workflow for these agent(s) 510, as shown by build workflow 515, resulting in the generation of the workflow 520. Notably, the workflow 520 is based at least partially on the orchestration. Service 505 will then execute and evaluate the agent(s) 510 in accordance with the workflow 520, as shown by evaluate workflow 525. Service 505 will also evaluate the agent(s) 510 ability to perform the task, as shown by evaluate task performance 530.

The workflow generation process flow 500 includes a decision step (i.e. decide workflow 535) in which the service 505 will decide whether an acceptable solution 540 has been generated for the given task. By “acceptable,” it is meant that the solution 540 satisfies the parameters and requirements of the complex task while also providing a response or answer to the complex task.

If the solution 540 is acceptable, the process flow 500 can end; otherwise, service 505 can further evaluate the performance of the agent(s) 510, as shown by evaluate task performance 545. Feedback on the attempted solution and the process can also be obtained and provided to the service 505, as shown by provide feedback 550. If no acceptable solution was generated during the first iteration of the process flow 500, service 505 can select a new set of agent(s) 510 and/or generate one or more new agents for use during a second or any number of subsequent iterations of the process flow 500.

As one example, it may be the case that for the first iteration, service 505 selected too few agents for inclusion in the listing of agent(s) 510. As a part of the second iteration and in response to feedback and evaluation data, service 505 can compensate and select a larger number of agents for inclusion in the listing of agent(s) 510. During the third iteration, service 505 might determine that too many agents were selected. To compensate, service 505 might select more agents than were used during the first iteration but fewer agents than were used during the second iteration.

The feedback and the evaluation data can be stored in the memory of the service 505. By storing this information, service 505 can learn from its past iterations and improve future iterations and future executions, even for different tasks. Thus, the service 505 is capable of enhanced learning over time.

In some implementations, service 505 may take a higher role and may not manage the specific interactions between the various different agents. For instance, a management agent can be employed and included in the list of agent(s) 510. This management agent can be the agent that supervises and controls the other agents while still operating under the direction of service 505. Thus, in some scenarios, once the agent(s) 510 are selected and the workflow is built, service 505 may no longer control the intricate operations of the agent(s) 510 because those agents are capable of self-management and because the management agent can attend to any specific management operations that may need to be performed as a part of the workflow. Optionally, the management agent can also assist in the generation of the workflow. Thus, the service 505 can delegate various responsibilities to the management agent.

It is sometimes the case that only the service 505 and/or the management agent is aware of the details included in the orchestration. The agents managed by the service 505 or the management agent are sometimes not made aware of the orchestration. As example will be helpful.

Suppose Agent A works to perform a task. Agent A will then report back to service 505 (or the management agent; the subsequent examples should be understood that the management agent can be used in place of the service 505). Service 505 then decides, based on the performance of Agent A, that Agent B should be called. Service 505 will then deliver whatever information is needed for Agent B to operate. Using the received data, Agent B will then operate and report back to the service 505, which may then call another agent.

In some scenarios, service 505 will permit an asynchronous operation in which Agent A is permitted to communicate directly with Agent B while also reporting back to the service 505. In some scenarios, a synchronous environment is employed where agents operate and then report the results to the service 505, which will then deliver those results to another agent for continued operation. Thus, the workflow is performed and the orchestration is adhered to by the service 505 controlling the operations. In the asynchronous example, the agents can optionally be provided limited information (as opposed to the full information in the orchestration) as to which other agents they can communicate with.

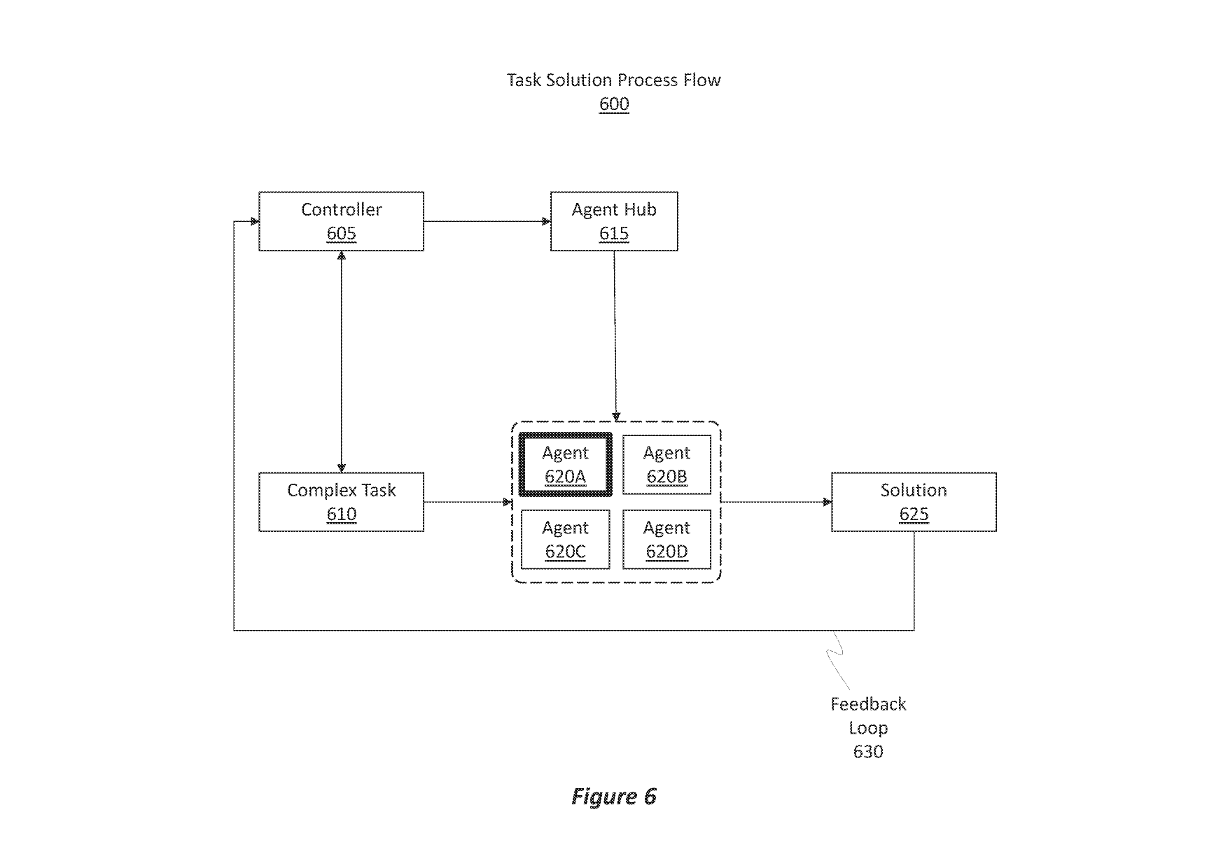

FIG. 6 shows a high level overview of the operations discussed herein. In particular, FIG. 6 shows an example task solution process flow 600, which can optionally be performed by the service 105 of FIG. 1.

FIG. 6 shows a controller 605, which can optionally be the disclosed service or which can optionally be an expert human developer. Preferably, the controller 605 is the service described herein.

The controller 605 receives a complex task 610. The controller 605 identifies the parameters and requirements of the complex task 610 and uses that information to query an agent hub 615. The agent hub 615 includes a plurality of pre-defined and standardized agents. An individual agent has an underlying core LLM along with a score card and a set of listed functionality. The agents also have names, descriptions, and prompts.

The controller 605 will determine whether any of the agents in the agent hub 615 are adequately (based on an evaluation using a similarity metric) configured to solve the complex task 610, such as by comparing similarity characteristics of the agents against the parameters and requirements of the complex task 610. If no agents are identified or meet the similarity threshold, then the controller 605 can trigger the creation or authorship of one or more agents. After creation, those agents are then stored in the agent hub 615. If one or more pre-defined agents are identified and determined to meet the similarity threshold, then those agents can be selected.

Regardless of whether the agents are created on-the-fly or are available within the agent hub 615, the controller 605 selects a set of agents for use, as shown by the agents 620A, 620B, 620C, and 620D. Although four agents are shown as being selected, one will appreciate how any number of agents can be used.

Agent 620A is shown as being emphasized using a bolded border. In this example scenario, agent 620A is the management agent and will control the workflow of the other agents 620B, 620C, and 620D. Controller 605 (or the agent 620A) also generates the orchestration that will control the behaviors of the agents 620B, 620C, and 620D. Additionally, controller 605 (or the agent 620A) will generate the workflow for the agents 620B, 620C, and 620D.

In this example scenario, agent 620A is then assigned responsibility to manage the workflow for the agents 620B, 620C, and 620D during runtime. The agents 620A, 620B, 620C, and 620D then operate in an attempt to generation a solution 625 to the complex task 610. During those operations, feedback can be acquired, and the feedback can be provided to the controller 605, as shown by the feedback loop 630. If the current set of agents 620A, 620B, 620C, and 620D is not adequate to generate the solution 625, then another iteration can be performed where a new set of agents is selected and executed.

Accordingly, at least some of the disclosed embodiments are beneficially able to automatically author and define any type of LLM agent. At least some of the embodiments are also able to generate an agent hub to retain the created agents. The agents in the agent hub are provided with a score card and a listed set of functionalities. These agents are available for selection by a service to complete a task. As a part of completing that task, at least some embodiments are beneficially able to generate a workflow to manage and control the operations of the agents that have been selected to complete the task.

The following discussion now refers to a number of methods and method acts that can be performed. Although the method acts can be discussed in a certain order or illustrated in a flow chart as occurring in a particular order, no particular ordering is required unless specifically stated, or required because an act is dependent on another act being completed prior to the act being performed.

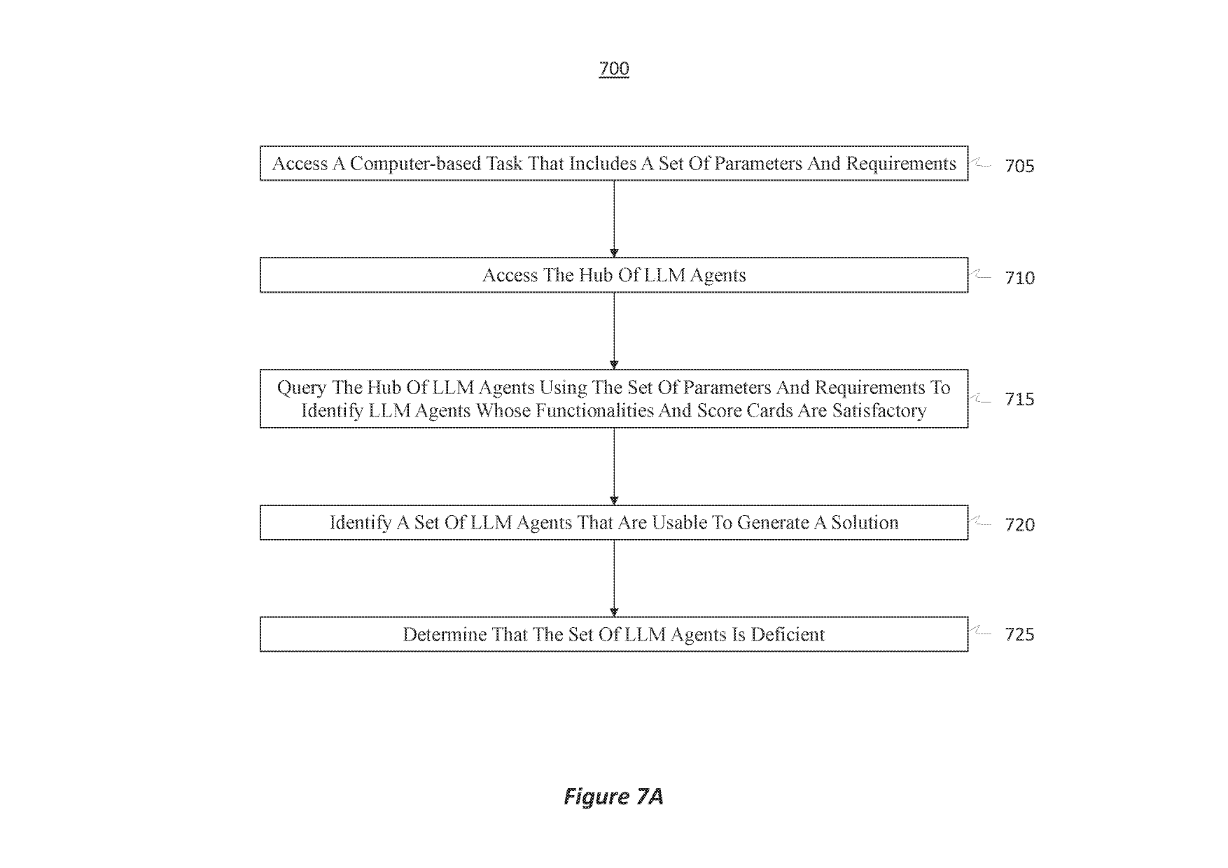

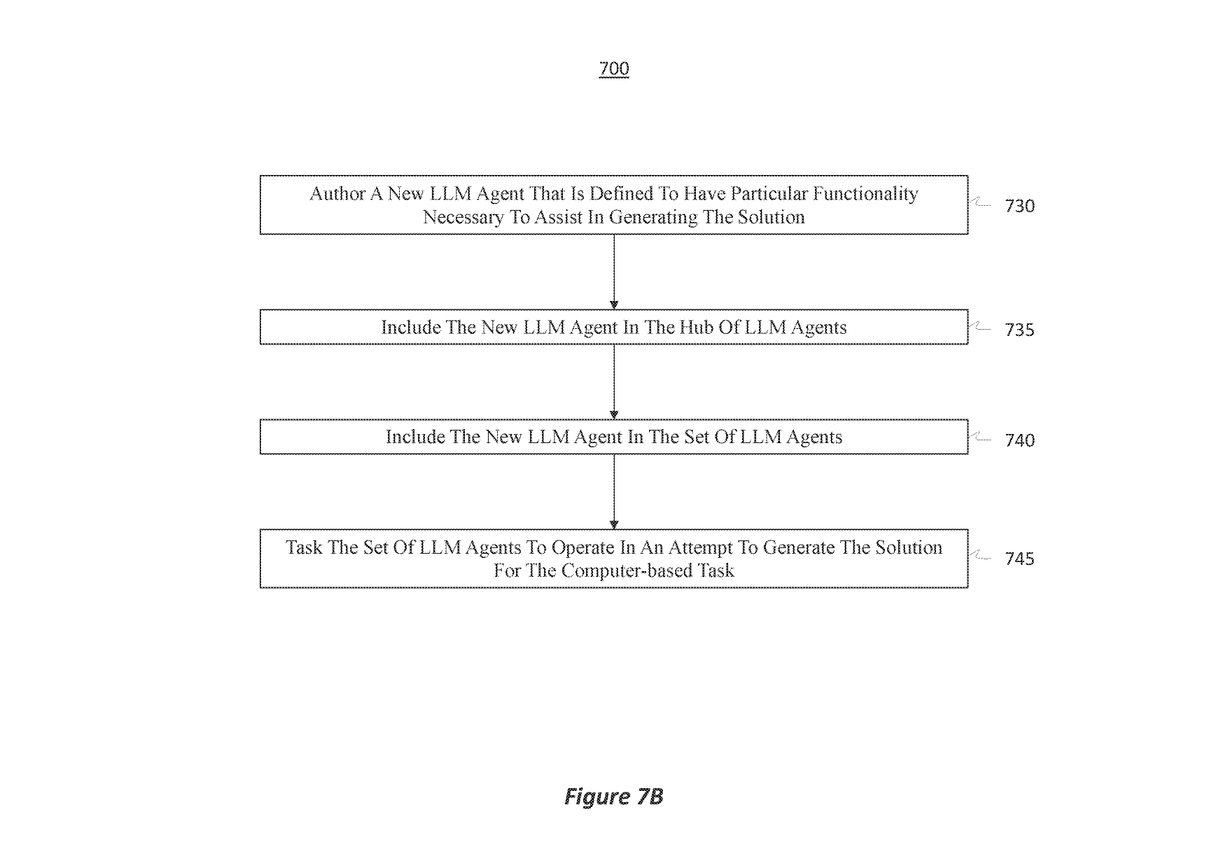

Attention will now be directed to FIGS. 7A and 7B, which illustrate flowcharts of an example method 700 for automatically enhancing a hub of large language model (LLM) agents. Method 700 can be performed within the architecture 100 of FIG. 1. Also, method 700 can be performed by a cloud-based service, such as service 105.

Method 700 includes an act (act 705) of accessing a computer-based task that includes a set of parameters and requirements.

Act 710 includes accessing the hub of LLM agents. The hub of LLM agents includes a plurality of different LLM agents, which include metadata comprising: (i) an identified core LLM used by LLM agent, (ii) a score card for LLM agent, and (iii) a listing of one or more functionalities LLM agent is able to perform.

Optionally, a score card for an LLM agent included in the hub of LLM agents includes a respective score for a plurality of different dimensional tests performed against the LLM agent. In one scenario, the plurality of different dimensional tests include a measurement performance test in which an error score is generated. In another scenario, the plurality of different dimensional tests include a causal analysis test in which a causal score is generated. In another scenario, the plurality of different dimensional tests include a fact checking test in which an explainability score is generated. In another scenario, the plurality of different dimensional tests include a bias checking test in which a fairness score is generated. In another scenario, the plurality of different dimensional tests include a RedTeam test in which a RedTeam score is generated.

In some scenarios, a score card for the LLM agent in the hub of LLM agents includes a plurality of different scores. For example, the plurality of different scores can include at least two of a RedTeam score, an error score, a causal score, an explainability score, and a fairness score.

Optionally, the hub of LLM agents can include additional information. For instance, the hub can include an agent name for the LLM agent, an agent description for the LLM agent, and a prompt for the LLM agent.

Act 715 includes querying the hub of LLM agents using the set of parameters and requirements to identify one or more LLM agents whose functionalities and score cards are determined to satisfy the set of parameters and requirements.

Based on the query, act 720 includes identifying a set of LLM agents that are at least partially usable or that are tasked with attempting to generate a solution for the computer-based task. The phrase “partially usable” generally refers to a scenario where the selected LLM agents include functionality that will purportedly enable those LLM agents to provide a solution to the given task. For instance, if the given task requires a URL analyzer, at least one of the LLM agents will include a URL analyzer functionality. Thus, the selected set of LLM agents are ones that are selected based on a prediction that they will be able to provide a response to the given task. Being “partially usable” does not necessarily guarantee that the selected set of LLM agents will be able to accomplish the task; rather, they are determined by the service to have a threshold level of likelihood in regards to being able to solve the task.

Act 725 includes determining that the set of LLM agents is deficient with respect to a particular functionality that is determined to be necessary to assist in generating the solution. For instance, the functionality of the set of LLM agents may overlap but not fully cover the functionality that is determined to be necessary. In some scenarios, the functionality may only partially fulfill the particular functionality, thereby resulting in a scenario where the set of LLM agents are deficient. Thus, to be “deficient,” a determination is made that the particular functionality likely cannot be fully serviced or cannot be serviced in a particular manner by the current set of LLM agents. As an example, suppose the set of LLM agents are able to achieve approximately 76% of the functionality that is determined to be necessary. In this situation, 76% is determined to be inadequate, and thus the set of LLM agents will be classified as being deficient. In response, a new LLM agent can be created, and that new LLM agent may have functionality that can 100% satisfy the particular functionality. In this sense, the set of LLM agents can be determined to be deficient if their performance will not meet or exceed a threshold performance level in performing or achieving the particular functionality. Stated differently, the set of LLM agents are determined to be deficient when the set of LLM agents are unable to achieve a threshold performance level with respect to the particular functionality.

Method 700 continued in FIG. 7B. In response to determining that the set of LLM agents is deficient, act 730 includes authoring, by the cloud-based service, a new LLM agent that is defined to have the particular functionality determined to be necessary to assist in generating the solution.

Act 735 includes including the new LLM agent in the hub of LLM agents. The new LLM agent is provided corresponding metadata detailing (i) a particular core LLM used by the new LLM agent, (ii) a particular score card for the new LLM agent, and (iii) a particular listing of functionalities for the new LLM agent. The particular listing of functionalities includes the particular functionality.

Act 740 includes including the new LLM agent in the set of LLM agents.

Act 745 includes tasking the set of LLM agents to operate in an attempt to generate the solution for the computer-based task.

In some implementations, an orchestration is defined for the set of LLM agents. The orchestration details which LLM agents are permitted to communicate with which other LLM agent. Often, the orchestration is statically defined.

In some implementations, a workflow is defined for the set of LLM agents. The workflow is dynamic and is controlled by the orchestration. That is, an end-to-end workflow is defined to govern operations of the set of LLM agents in attempting to generate the solution.

In one example scenario, the set of LLM agents fail to generate the solution for the computer-based task. In response, a new set of LLM agents is selected and is tasked to operate in an attempt to generate the solution. This new set of LLM agents are selected based on feedback obtained when the set of LLM agents operated. Optionally, a new LLM agent is dynamically created in response to a determination that the hub of LLM agents is deficient in view of the set of LLM agents failing. For instance, the set of LLM agents might fail when they are unable to produce an answer or a response to the task. In another scenario, the set of LLM agents might fail if they produce a response, but they produce the response in a slow manner or in a manner that exceeds a given timing threshold. In another scenario, the set of LLM agents might fail if the confidence metric assigned to the response they provide is lower than a confidence threshold. Thus, when any of the above scenarios occur, or potentially when other scenarios occur, the set of LLM agents can be identified as being deficient.

In one scenario, at least one LLM agent included in the set of LLM agents is a uniform resource locator (URL) analyzer agent. Of course, other types of LLM agents can be used.

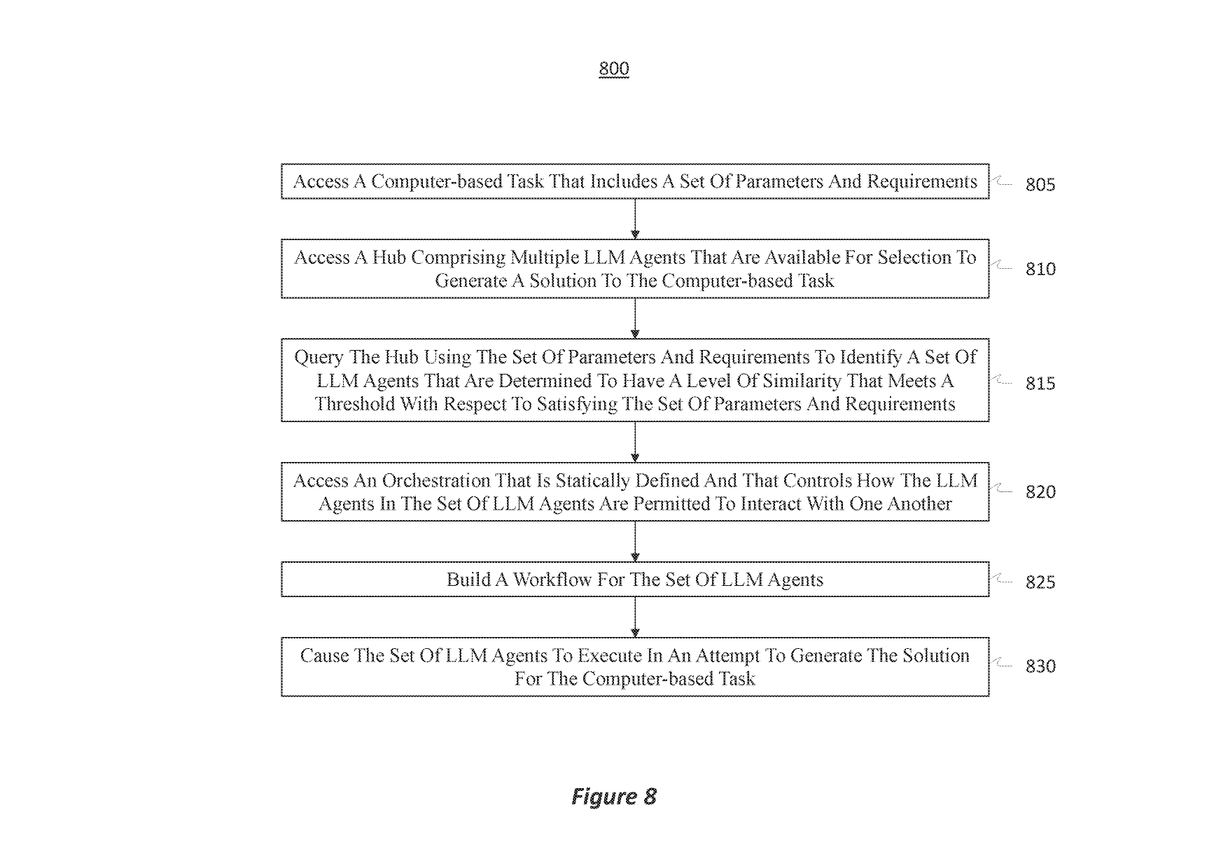

FIG. 8 shows a flowchart of an example method 800 for authoring an end-to-end workflow for a set of large language model (LLM) agents tasked with generating a solution to a computer-based task. Method 800 can also be implemented within architecture 100 and by service 105.

Method 800 includes an act (act 805) of accessing a computer-based task that includes a set of parameters and requirements. Act 810 includes accessing a hub comprising multiple LLM agents that are available for selection to generate a solution to the computer-based task.

Act 815 includes querying the hub using the set of parameters and requirements. This querying is performed to identify a set of LLM agents that are determined to have a level of similarity that meets a threshold with respect to satisfying the set of parameters and requirements.

Act 820 includes accessing an orchestration that is statically defined. The orchestration controls how the LLM agents in the set of LLM agents are permitted to interact with one another.

Act 825 includes building a workflow for the set of LLM agents. The workflow is structured to control run-time interactions between the LLM agents in the set of LLM agents and being dependent on the orchestration.

Act 830 includes causing the set of LLM agents to execute in an attempt to generate the solution for the computer-based task. The set of LLM agents, during run-time, are governed by the workflow.

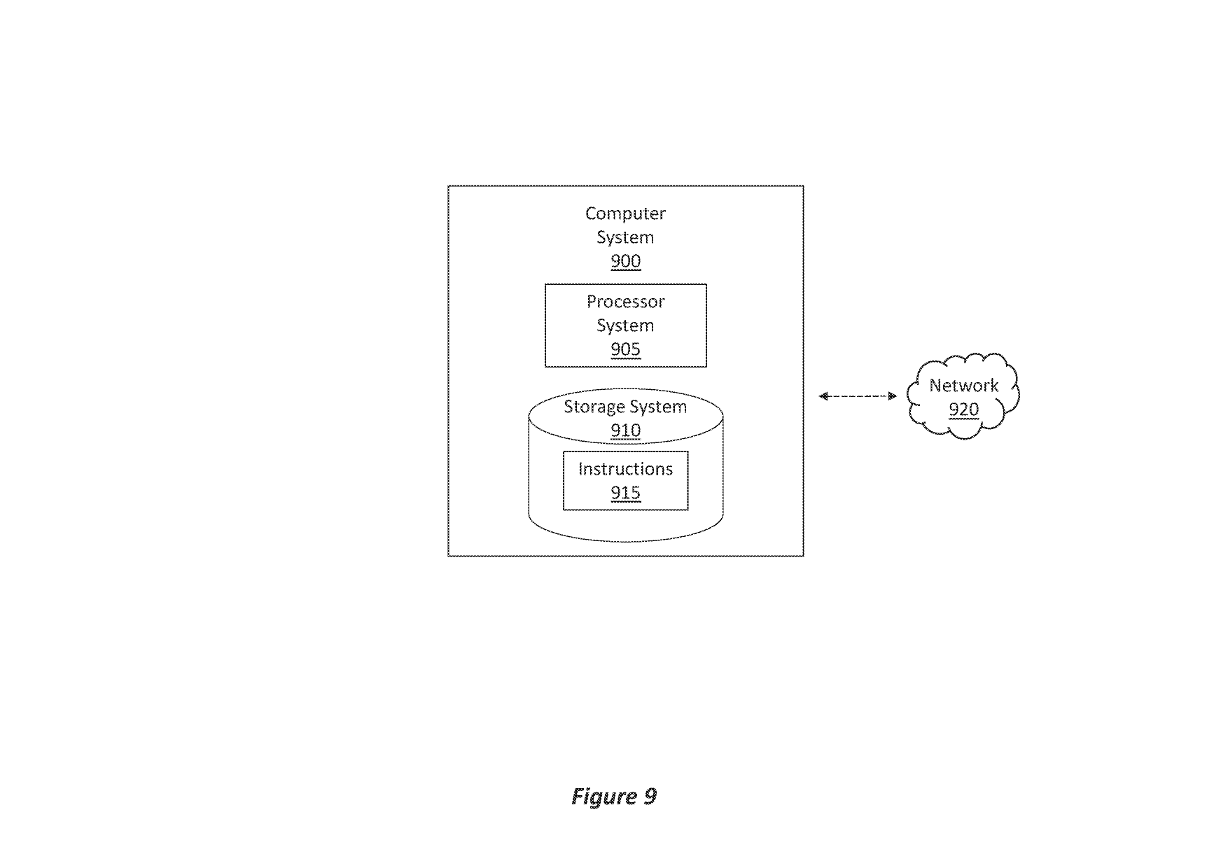

Attention will now be directed to FIG. 9 which illustrates an example computer system 900 that can include and/or be used to perform any of the operations described herein. Computer system 900 can take various different forms. For example, computer system 900 can be embodied as a tablet, a desktop, a laptop, a mobile device, or a standalone device, such as those described throughout this disclosure. Computer system 900 can also be a distributed system that includes one or more connected computing components/devices that are in communication with computer system 900. Computer system 900 can implement the architecture 100 of FIG. 1, and computer system 900 can host the service 105.

In its most basic configuration, computer system 900 includes various different components. FIG. 9 shows that computer system 900 includes a processor system 905 that includes one or more processor(s) and a storage system 910.

Regarding the processor(s) of the processor system 905, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that can be executed on computer system 900. The different components, modules, engines, and services described herein can be implemented as objects or processors that execute on computer system 900 (e.g. as separate threads).

Storage system 910 can be physical system memory, which can be volatile, non-volatile, or some combination of the two. The term “memory” can also be used herein to refer to non-volatile mass storage such as physical storage media. If computer system 900 is distributed, the processing, memory, and/or storage capability can be distributed as well.

Storage system 910 is shown as including executable instructions 915. The executable instructions 915 represent instructions that are executable by the processor(s) of the processor system 905 to perform the disclosed operations, such as those described in the various methods.

The disclosed embodiments can comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 900 can also be connected (via a wired or wireless connection) to external sensors (e.g., one or more remote cameras) or devices via a network 920. For example, computer system 900 can communicate with any number devices or cloud services to obtain or process data. In some cases, network 920 can itself be a cloud network. Furthermore, computer system 900 can also be connected through one or more wired or wireless networks to remote/separate computer systems(s) that are configured to perform any of the processing described with regard to computer system 900.

A “network,” like network 920, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 900 will include one or more communication channels that are used to communicate with the network 920. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions can be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that at least some embodiments can be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. At least some embodiments can also be practiced in distributed system environments where local and remote computer systems that are linked (either by hardwired data links, wireless data links, or by a combination of hardwired and wireless data links) through a network perform tasks (e.g. cloud computing, cloud services and the like). In a distributed system environment, program modules can be located in both local and remote memory storage devices.

The present invention can be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for automatically enhancing a hub of large language model (LLM) agents, said method being performed by a cloud-based service and comprising:
accessing a computer-based task that includes a set of parameters and requirements;
accessing the hub of LLM agents, wherein the hub of LLM agents includes a plurality of different LLM agents, which include metadata comprising: (i) an identified core LLM used by said LLM agent, (ii) a score card for said LLM agent, and (iii) a listing of one or more functionalities said LLM agent is able to perform;
querying the hub of LLM agents using the set of parameters and requirements to identify one or more LLM agents whose functionalities and score cards are determined to satisfy the set of parameters and requirements;
based on said querying, identifying a set of LLM agents that are tasked with attempting to generate a solution for the computer-based task;
determining that the set of LLM agents is deficient with respect to a particular functionality that is determined to be necessary to assist in generating the solution, wherein the set of LLM agents are determined to be deficient when the set of LLM agents are unable to achieve a threshold performance level with respect to the particular functionality;
in response to determining that the set of LLM agents is deficient, authoring, by the cloud-based service, a new LLM agent that is defined to have the particular functionality determined to be necessary to assist in generating the solution;
including the new LLM agent in the hub of LLM agents, wherein the new LLM agent is provided corresponding metadata detailing (i) a particular core LLM used by the new LLM agent, (ii) a particular score card for the new LLM agent, and (iii) a particular listing of functionalities for the new LLM agent, the particular listing of functionalities including the particular functionality;
including the new LLM agent in the set of LLM agents; and
tasking the set of LLM agents to operate in an attempt to generate the solution for the computer-based task.

2. The method of claim 1, wherein a given score card for a given LLM agent included in the hub of LLM agents includes a respective score for a plurality of different dimensional tests performed against said LLM agent.

3. The method of claim 2, wherein the plurality of different dimensional tests include a measurement performance test in which an error score is generated.

4. The method of claim 2, wherein the plurality of different dimensional tests include a causal analysis test in which a causal score is generated.

5. The method of claim 2, wherein the plurality of different dimensional tests include a fact checking test in which an explainability score is generated.

6. The method of claim 2, wherein the plurality of different dimensional tests include a bias checking test in which a fairness score is generated.

7. The method of claim 2, wherein the plurality of different dimensional tests include a RedTeam test in which a RedTeam score is generated.

8. The method of claim 1, wherein an orchestration is defined for the set of LLM agents, and wherein the orchestration details which LLM agents are permitted to communicate with which other LLM agent.

9. The method of claim 8, wherein the orchestration is statically defined.

10. The method of claim 8, wherein a workflow is defined for the set of LLM agents, wherein the workflow is dynamic and is controlled by the orchestration.

11. A computer system comprising:
a processor system; and
a storage system that stores instructions that are executable by the processor system to cause the computer system to:
access a computer-based task that includes a set of parameters and requirements;
access a hub of LLM agents, wherein the hub of LLM agents includes a plurality of different LLM agents, which include metadata comprising: (i) an identified core LLM used by said LLM agent, (ii) a score card for said LLM agent, and (iii) a listing of one or more functionalities said LLM agent is able to perform;
query the hub of LLM agents using the set of parameters and requirements to identify one or more LLM agents whose functionalities and score cards are determined to satisfy the set of parameters and requirements;
based on said querying, identify a set of LLM agents that are usable to attempt to generate a solution for the computer-based task; and
task the set of LLM agents to operate in an attempt to generate the solution for the computer-based task.

12. The computer system of claim 11, wherein the hub of LLM agents further includes an agent name for a given LLM agent, an agent description for the LLM agent, and a prompt for the LLM agent.

13. The computer system of claim 11, wherein a given score card for a given LLM agent in the hub of LLM agents includes a plurality of different scores.

14. The computer system of claim 13, wherein the plurality of different scores includes at least two of a RedTeam score, an error score, a causal score, an explainability score, and a fairness score.

15. The computer system of claim 11, wherein the set of LLM agents fail to generate the solution for the computer-based task, and wherein a new set of LLM agents is selected and is tasked to operate in an attempt to generate the solution.

16. The computer system of claim 15, wherein the new set of LLM agents are selected based on feedback obtained when the set of LLM agents operated.

17. The computer system of claim 16, wherein a new LLM agent is dynamically created in response to a determination that the hub of LLM agents is deficient in view of the set of LLM agents failing.

18. The computer system of claim 11, wherein an end-to-end workflow is defined to govern operations of the set of LLM agents in attempting to generate the solution.

19. The computer system of claim 11, wherein at least one LLM agent included in the set of LLM agents is a uniform resource locator (URL) analyzer agent.

20. A storage system that stores instructions that are executable by one or more processors to cause the one or more processors to:
access a computer-based task that includes a set of parameters and requirements;
access a hub of LLM agents, wherein the hub of LLM agents includes a plurality of different LLM agents, which include metadata comprising: (i) an identified core LLM used by said LLM agent, (ii) a score card for said LLM agent, and (iii) a listing of one or more functionalities said LLM agent is able to perform;
query the hub of LLM agents using the set of parameters and requirements to identify one or more LLM agents whose functionalities and score cards are determined to satisfy the set of parameters and requirements;
based on said querying, identify a set of LLM agents that are usable to attempt to generate a solution for the computer-based task; and
task the set of LLM agents to operate in an attempt to generate the solution for the computer-based task.
